(19) United States
(12) Patent Application Publication
(10) Pub. No.: US 2006/0283865 A1
(43) Pub. Date: Dec. 21, 2006

(54) Laminated copper article of cookware

(75) Inventor: Stanley Kin Sui Cheng, Vallejo, CA (US)

Correspondence Address: MEYER CORPORATION, U.S.;ATTN: EDWARD S. SHERMAN, ESQ., ONE MEYER PLAZA, VALLEJO, CA, 94590, US

(73) Assignee: Meyer Intellectual Properties Ltd.

(21) Appl. No.: 11/157,351

(22) Filed: Jun. 21, 2005

(51) Int. Cl. A47J 37/01

(52) U.S. Cl. 220/573.1

(57) ABSTRACT

A process of brazing is used to bond copper and stainless steel preformed vessels to form laminated cookware. The process includes an ironing step that is carried out after brazing, in part to improve the integrity of the bond. The ironing step also provides a means to reduce the thickness of the copper in the upright wall portion of the vessel. This yields a lighter weight article of cookware, as compared to one formed from a pre-laminated sheet of copper and stainless steel layers.

### CROSS REFERENCE TO RELATED APPLICATIONS None

### BACKGROUND OF INVENTION

The present invention relates to an improved article of cookware and a method of manufacturing the same.

Copper based cookware is well known, having as its primary advantage the rapid heating of the cookware and hence foodstuffs therein, due to the higher thermal conductivity of copper over other metals.

In some instances, the high thermal conductivity of copper is in fact a hindrance to the chef. This is particularly true if the heat source itself is spatially uneven, such as for a gas flame burner. Accordingly, it is desirable that the copper thickness has a thickness of least about 1.5 mm to provide for the lateral spreading of the heat to minimize the hot spots that would occur in parts of the pan bottom.

However, other properties of copper have made it undesirable as the sole material in cookware for some consumers. For example, one undesirable aspect of copper cookware is that it tarnishes relatively easily and in particular when the interior cooking surface is exposed to acidic foods.

This problem has in part been solved by manufacturing cookware from laminates of copper between other material, and in particular between stainless steel. The stainless steel, although offering physical protection on both sides of the copper, and tends to negate the inherent benefits of its higher thermal conductively, having about 1/25^{th} the thermal conductivity of copper.

Copper cookware also tends to be heavier than stainless steel cookware, having a density that is about 10% greater than stainless steel.

Accordingly, it would be desirable to provide cookware having most of the thermal benefits of copper, yet at a reduced total weight.

It is therefore a first object of the present invention to provide a lighter weight laminated cookware article that comprises copper between stainless steel layers.

It is another object of the invention to provide a lighter weight laminated cookware article that comprises copper between stainless steel layers, yet has the thermal properties and response similar to thick copper cookware.

### SUMMARY OF INVENTION

In the present invention, the first object is achieved by forming an article of cookware wherein a copper fluid containing vessel is lined with an interior of stainless steel. Although the copper cladding initially has a constant thickness, the process of bonding the stainless steel liner is also used to thin the portion of the copper cladding in the sidewalls of the cookware article with respect to the copper in the bottom surface.

A second aspect of the invention is the discovery of a cost effective method of forming clad cookware by first forming vessels from individual metal sheet and then boding them in a process that includes two or more steps, one of which reduces the thickness of the copper in the sidewalls of the cookware article.

The above and other objects, effects, features, and advantages of the present invention will become more apparent from the following description of the embodiments thereof taken in conjunction with the accompanying drawings.

### BRIEF DESCRIPTION OF DRAWINGS

FIG. 1 is a cross-sectional elevation of an article of cookware according to a first embodiment of the invention.

FIG. 2 is a schematic diagram illustrating the steps in the process used to fabricate the article of cookware of FIG. 1.

FIG. 3 is a cross-sectional elevation of an article of cookware according to a second embodiment of the invention.

FIG. 4 is a schematic diagram illustrating the steps in the process used to fabricate the article of cookware of FIG. 3.

FIG. 5 is a cross-sectional elevation of an article of cookware according to another embodiment of the invention.

### DETAILED DESCRIPTION

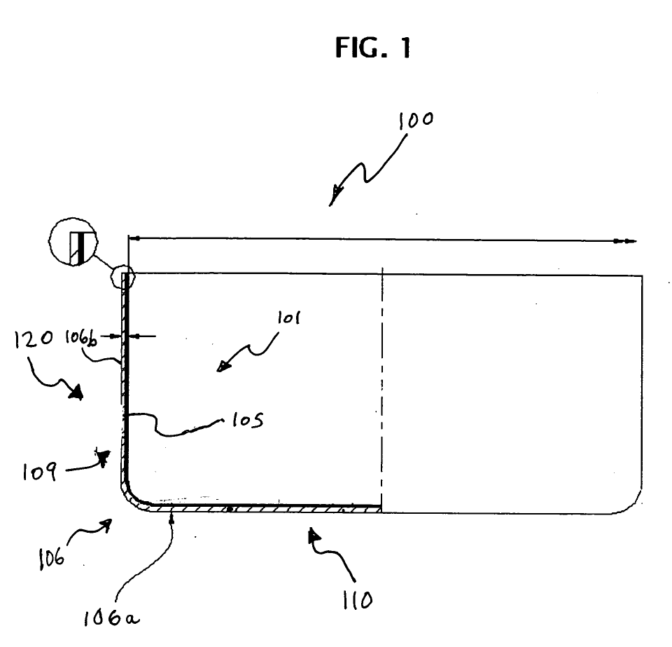

Referring to FIGS. 1 through 5, wherein like reference numerals refer to like components in the various views, there is illustrated therein a new and improved clad article of cookware, generally denominated 100 herein.

In accordance with the present invention, FIG. 1 illustrates a first embodiment of the invention in which an article of cookware 100 has a bottom cooking surface 110 surrounded by an upward extending sidewall 120 to form a fluid containing vessel. The article of cookware 100 generally also includes one or more sideward extending handles, which are not shown in the drawing. The sidewall 120 and bottom 110 have a laminated construction in which the entire inner cooking surface 101 is lined with a layer of stainless steel 105 that is in turn surrounded by an exterior layer 109 of copper cladding 106. A portion of the copper cladding 106a is about 1.5 mm thick at the bottom cooking surface 110, whereas another portion of the copper cladding 106b in the sidewall has a thickness that is preferably no more than about 90% of thickness at the bottom cooking surface, that is less than about 1.3 to 1.4 mm. The inner lining of stainless steel is preferably grade 304. The interior stainless steel lining 105 protects the interior surface of the copper from tarnishing with use, providing a surface that is easier to clean after cooking. The stainless steel layer 105 also strengthens the article of cookware 100 such that the copper layer 106 does not need to be thicker than about 1.5 mm, helping to reduce the cookware weight without a significant degradation in thermal responsiveness. The cookware weight is further reduced by making the sidewall portion 106b of copper layer 106 in the sidewall 112 thinner than the copper layer 106a in the bottom-cooking surface 110, which is required for thermal performance. Preferably, the copper layer 106a in the bottom surface 110 has a thickness of about 1.5 mm, whereas the portion of the copper layer 106b in the sidewall 120 has a thickness of about 1.2 mm. The stainless steel layer 105 that forms the interior surface 101 of the cooking vessel preferably has a constant thickness of about 0.6 mm, resulting in a total thickness of about 2.10 mm for the bottom cooking surface 110. In contrast, the sidewall 120 has a total thickness of about 1.8 mm. More generally, it is preferable that the copper in the sidewall is no more than about 80% of the thickness of the copper in the bottom of the pan.

The inventors believe that it has not heretofore been appreciated that such modest reductions in wall thickness can translate into comparable reductions in the weight of the cookware article. This is best understood by considering that for a cylindrical article of cookware, the ratio of the sidewall area to the bottom area is 2h/r, where r is the radius of the cookware article and h is the depth of the cookware article. For most cookware shapes, this ratio is between about 1 to about 2.8. Thus, as the stainless steel liner is only slightly more than a third the thickness of the copper at the bottom surface, reducing the copper thickness in the sidewall can translate into a noticeable weight reduction in the cookware article.

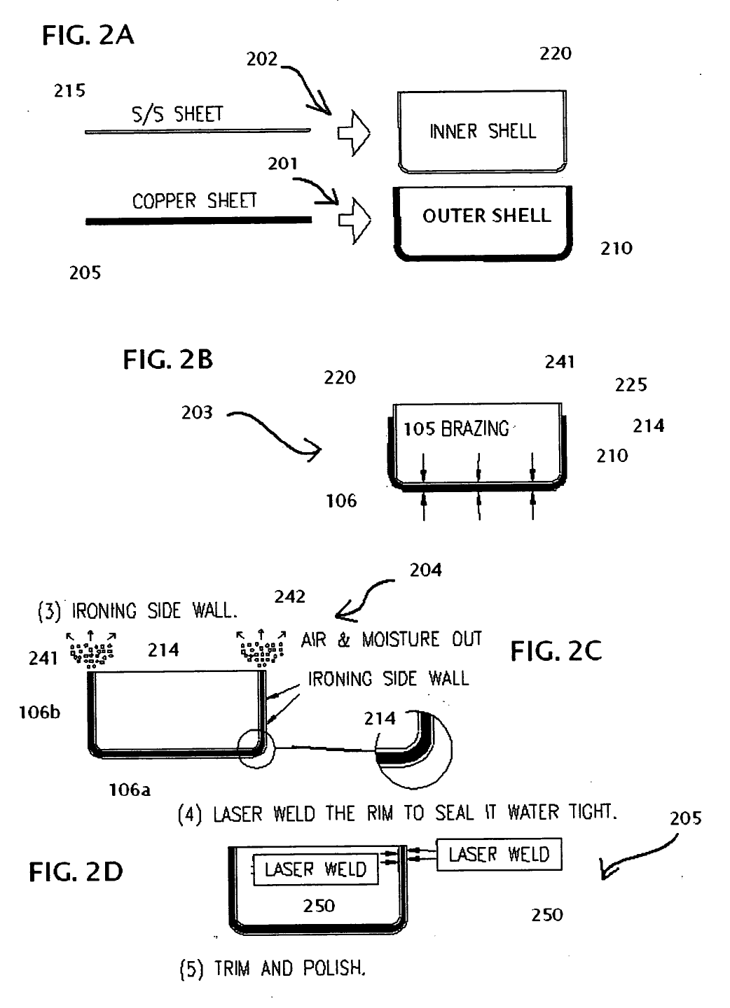

FIG. 2 illustrates another embodiment of the invention in which a novel sequence of steps is used to fabricate the article of cookware 100, shown in FIG. 1. The process described with respect to FIG. 2 has two advantages. First, it provides a cost savings compared to forming a cooking vessel by deforming a sheet of clad metal comprising a uniform layer of stainless steel bonded to a uniform layer of copper. Further, the process allows the copper exterior to be made thinner in the sidewall than in the bottom of the pan, where the extra thickness of the copper results in improved temperature uniformity across the bottom surface 110 during cooking. This construction reduces the weight of the pan, as compared to deploying a copper layer with a constant thickness of 1.5 mm. The resulting cookware article is lighter and thus easier for the user or consumer to handle.

In step 201, shown in FIG. 2A, a substantially planar sheet of copper 205, or an alloy thereof, is drawn to form a fluid containing vessel or outer shell 210. In this embodiment, outer shell 210 will become the exterior of the completed cooking vessel 100.

In step 202, also shown in FIG. 2A, a substantially planar sheet of stainless steel, preferably grade 304 alloy, 215 is drawn to form a fluid containing liner or inner shell 220. However, to the extent that it is desirable to utilize the completed article of cookware with induction cooking, stainless steel grade 430 is preferred.

In step 203, shown in FIG. 2B, the inner shell 220 is nested within the outer shell 210, forming subassembly 225. A brazing compound is applied to at least one of the exterior of the inner shell 220 or the interior of the outer shell 210 prior to the nesting.

Also in step 203, to complete the brazing process, the temperature of the subassembly is raised to melt the brazing compounding, which upon cooling forms a metallurgical bond at interface 214, uniting the inner shell 220 and the outer shell 210. Pressure is applied to compress the inner and outer shells against each other at the common interface 214, facilitating the consolidation and flow of the liquid brazing compound. It should be appreciated that each of the shells 220 and 210 are drawn in steps 201 and 202 with sufficient dimension tolerances to facilitate complete insertion of the inner shell 220 in the inner shell 210. A slight gap is also provided to accommodate the solid brazing compound (as well as for the eventual wicking of the molten brazing compound or liquid flux) at the common interface, 214, of subassembly 230.

Shown schematically in FIG. 2C is step 204, an “ironing process” to reduce the thickness of the sidewall 120. “Ironing” is done by the continued deep drawing of subassembly 225 in a set of dies with the clearance between male and female die members that is smaller than the actual combined thicknesses of the sidewall 120. As the copper outer layer 106b, is much softer than stainless steel 105, only the thickness of the copper layer 106b is reduced. As it can be difficult in the brazing process of step 203 to fully reflow the liquid flux over the entire areas to be bonded in interface 214, air and moisture can be trapped within this gap. The “ironing process” has another advantage in that it gradually expels air and moisture trapped at the common interface 214. As the stainless steel layer 105 is not drawn the “ironing” 204, it will remain the same height as when formed in 202, defining rim 241. However, as the wall thickness of the copper layer 106b is reduced, the height of this wall will increase from that resulted from forming step 210.

While it is possible to initially form both the inner shell 220 and outer shell 210 with a predetermined difference in initial wall heights with the intention that they become uniform during the “ironing” process of step 204, it is preferable to trim the sidewall 120 to define the final rim height after the “ironing” process. This trimming step may utilize conventional mechanical cutting tools, water jet cutting, laser cutting and the like.

When the trimming step is performed after “ironing” it is more preferable to utilize laser welding to fully bond and thus tightly seal the inner shell 220 to the outer shells 210 at the intended rim position, shown schematically as step 205 in FIG. 2D. In step 205, the laser beam 250 is focused to heat the intended trim area. Laser welding is well known in the art of metal fabrication. One of ordinary skill in this art can readily determine the optimum laser welding conditions appropriate to the thickness, absorption and heat capacity of the copper and stainless steel layers at the weld location by routine experimentation.

After trimming the article of cookware, it is preferably polished to achieve the desired aesthetic appearance. After the trimming and polishing steps in the fabrication process shown in FIG. 2A-2D, one or more handles are generally attached to sidewall 120.

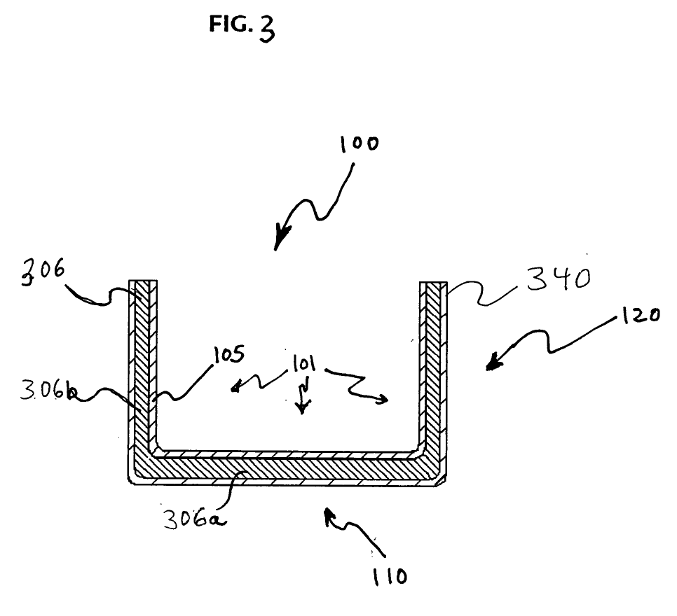

FIG. 3 illustrates another embodiment of the invention in which an article of cookware 100 has a bottom cooking surface 110 surrounded by an upward extending sidewall 120 to form a fluid containing vessel. The sidewall and bottom have a laminated construction in which the entire inner cooking surface 101 is lined with a layer of stainless steel 105. Stainless steel layer 105 is surrounded on the exterior surface by a layer of copper cladding 306. The copper cladding 306 is 1.5 mm thick in the bottom portion 306a, whereas the thickness in the sidewall portion 306b is about 1.2 mm thick. An outer stainless steel protective layer 340 surrounds the inner copper cladding 306. The inner and outer linings of stainless steel are preferably grade 304, and more preferably have a constant thickness of about 0.6 mm. As in the cookware article 100 of FIG. 1, this cooking vessel advantageously deploys thinner copper in the sidewalls 120 than is required in the bottom-cooking surface 110 to achieve a substantially uniform temperature, thus reducing the total weight of the cookware article.

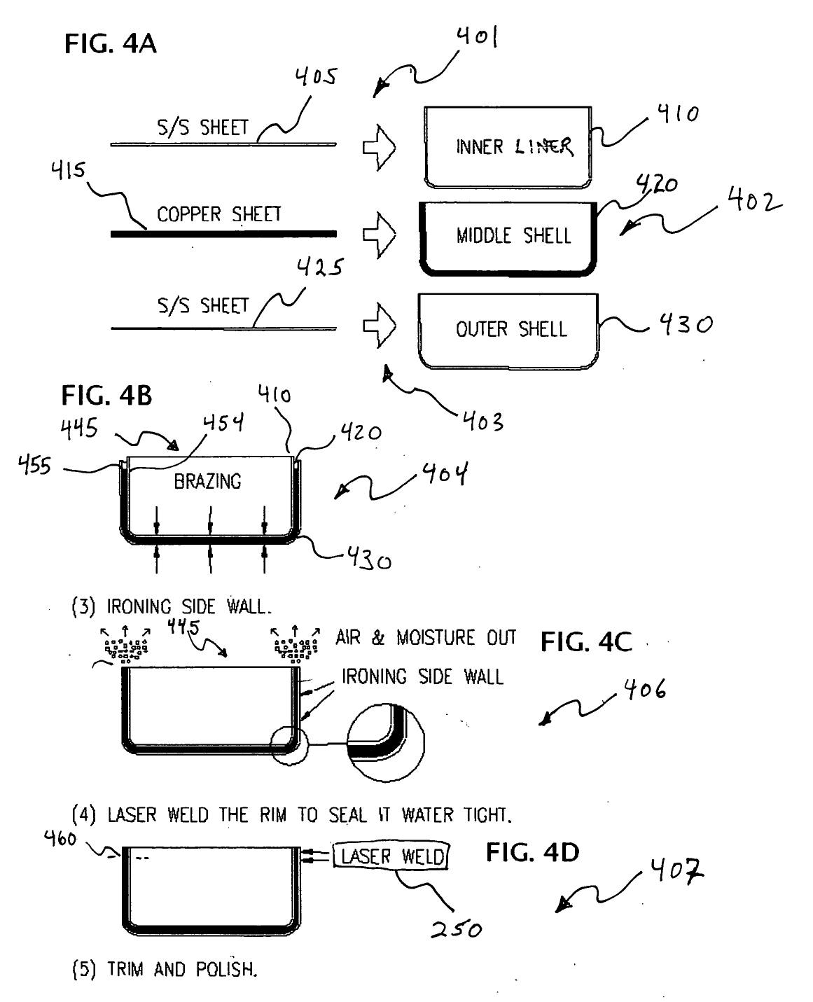

Further, the fabrication processes used to form cookware article 100 of FIG. 3, as illustrated in FIG. 4, has a lower manufacturing cost savings than constructing a comparable article of cookware starting from a triple ply clad sheet that comprise a stainless steel/copper/stainless steel construction.

In step 401, shown in FIG. 4A, a substantially planar sheet of stainless steel, preferably grade 304 alloy, 405 is drawn to form an fluid containing inner liner 410.

In step 402, shown in FIG. 4A, a substantially planar sheet of copper 415, or an alloy thereof, is drawn to form a fluid containing vessel or middle shell 420.

In step 403, also shown in FIG. 4A, a substantially planar sheet of stainless steel 425, preferably grade 430 alloy, is drawn to form a fluid containing vessel or outer shell 430. Grade 430 stainless steel grade is preferred so that the completed article of cookware can be used for induction cooking.

In step 404, shown in FIG. 4B, the fluid containing inner liner 410 is nested within the middle shell 420. A brazing compound is applied to at least one of the exterior of the inner liner 410 or the interior of middle shell 420. Further, the middle shell 420, including inner line 410, is nested within outer shell 430, forming subassembly 445. Likewise, a brazing compound is applied to at least one of the exterior of the middle shell 420 and the interior of the outer shell 430.

It should be appreciated that each of the liner 410 and shells 420 and 430 are drawn in steps 401, 402 and 403 with sufficient dimension tolerances to facilitate complete insertion in the nested arrangement of subassembly 445, with a slight gap at each interface to accommodate the brazing compound and the eventual wicking of the molten brazing compound.

Also in step 404, to complete the brazing process, the temperature of the subassembly is raised to melt the brazing compound, which upon cooling forms a metallurgical bond at interfaces 454 and 455, substantially bonding each liner or shell to the next larger shell in subassembly 445. Liner 410 and shells 420 and 430 are also pressed together enabling the consolidation and flow of the liquid brazing compound at their respective common interfaces 454 and 455.

It should be appreciated that the liner 410 and shells 420 and 430 can be nested in an alternative sequence and be braised in multiple, rather than a single step, if desired. Preferably, the subsequent “ironing” process of step 406 of FIG. 4C is done after the bonding of the three liner/shells formed in steps 401, 402 and 403 by brazing in step 404. As described with respect to FIG. 2C, the “ironing process” not only reduces the copper thickness in sidewall 120, but also expels trapped air and moisture from interface 454 and 455.

As in forming cooking vessel 100 in FIG. 2, laser welding in step 407 is carried out after “ironing” in step 406, following by trimming to form rim 460, as indicated by the dotted line in FIG. 4D.

After trimming, the article of cookware is polished to the aesthetically desired final finish. One or more side handle are generally attached after the trimming and polishing steps in the fabrication process.

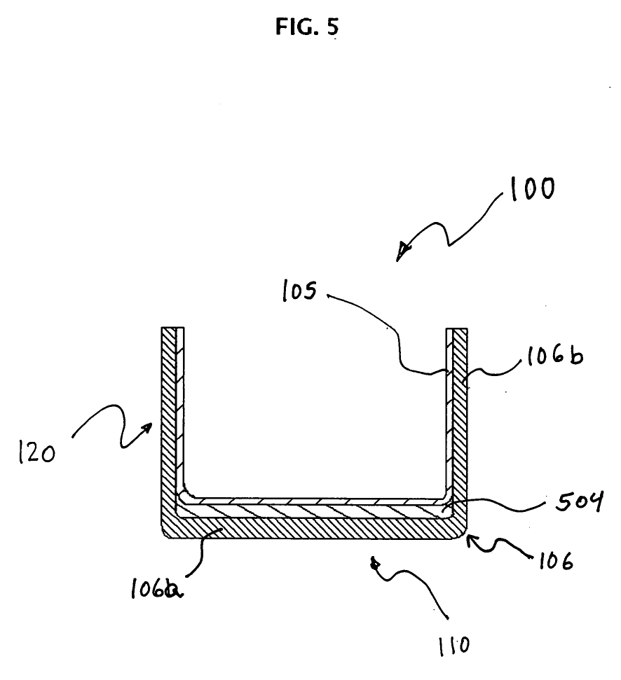

In accordance with another aspect of the present invention, FIG. 5 illustrates another embodiment of the invention in which an article of cookware 100 has a bottom cooking surface 110 surrounded by an upward extending sidewall 120 to form a fluid containing vessel. The sidewall and bottom have a laminated construction in which the entire inner cooking surface is lined with a layer of stainless steel 105 and the outside of the article of cookware is a copper cladding 106. At the bottom of the article of cookware 100 is disposed a layer of aluminum 504, or an alloy thereof, having a thickness of between about 2 mm to about 7 mm, disposed between the interior stainless steel lining 105 and the exterior copper cladding 106. As the aluminum layer 504 only extends across the bottom-cooking surface 110, the upward extending sidewall 112 comprises a laminate of copper 106b and stainless steel 105.

The above construction is highly advantageous as the aluminum layer 504, depending on the relative thickness with respect to the copper layer, helps to spread heat laterally. However, as the aluminum 504 is not disposed within the sidewall 112 of the cooking vessel, the lateral spread of heat is predominantly in the bottom of the cookware. Further, this construction avoids having to construct an article of cookware from an expensive triple laminated sheet of copper/aluminum/stainless steel.

The article of cookware 100 in FIG. 5 can be fabricated by impact bonding an aluminum slab or sheet that is pre-cut into a circle to one or both of the stainless steel or copper layers shown in FIG. 2. The step of impact bonding either can be carried out before or after the stainless steel or copper sheets are formed into vessels by the drawing process described in steps 201 and 202 of FIG. 2.

While the invention has been described in connection with a preferred embodiment, it is not intended to limit the scope of the invention to the particular form set forth, but on the contary, it is intended to cover such alternatives, modifications, and equivalents as may be within the spirit and scope of the invention as defined by the appended claims.

1. An article of cookware comprising:
a) a bottom surface,
b) surrounding sides extending upward therefrom to form a fluid containing vessel,
c) wherein the interior of the vessel has a stainless steel lining and the exterior of the vessel has a copper cladding, the copper cladding layer being thicker in the portion that comprises said bottom surface than in the portion that comprises said surrounding sides.

2. The article of claim 1 wherein the vessel is formed by braising a preformed stainless steel liner into a preformed copper shell.

3. The article of claim 2 wherein the braised assembly of the preformed stainless steel liner and preformed copper shell is ironed to eliminate any air and moisture trapped at the interface there between.

4. An article according to claim 3 wherein the step of ironing has reduced the thickness of the copper cladding in the portion that comprises the surrounding sides of the cookware article.

5. The article of cookware of claim 1 wherein the copper cladding layer at said bottom surface has a thickness of at least 1.5 mm.

6. The article of cookware of claim 5 wherein the copper in said surrounding sides has a thickness of less than about 1.4 mm.

7. The article of cookware of claim 1 wherein the copper in said surrounding sides has a thickness that is no more than about 90% of the thickness of the copper in said bottom surface.

8. The article of cookware of claim 1 wherein the copper in said surrounding sides has a thickness no more than about 80% of the thickness of the copper in said bottom surface.

9. The article of cookware of claim 1 further comprising a layer of aluminum disposed between the copper cladding and the stainless steel lining, said aluminum layer extending over said bottom surface.

10. An article of cookware comprising:
a) a bottom cooking surface,
b) surrounding sides extending upward therefrom to form a fluid containing vessel,
c) wherein each of the bottom and surrounding side are a contiguous laminate that comprises:
i) a first inner layer of stainless steel that lines the interior of the vessel,
ii) a second exterior layer of stainless steel cladding the exterior of the vessel,
d) a middle layer of copper disposed between the inner and exterior stainless steel layers, wherein the copper layer is thicker in the portion that comprises said bottom-cooking surface than in the portion that comprises said surrounding sides of the vessel.

11. An article of cookware according to claim 10 formed by braising a preformed stainless steel liner into a preformed copper shell.

12. An article of cookware according to claim 11 wherein the braised assembly of the preformed stainless steel liner and preformed copper shell has been ironed to eliminate any air and moisture trapped at the interface there between.

13. An article according to claim 12 wherein the step of ironing has reduced the thickness of the copper cladding in the portion that comprises said surrounding sides of the cookware article.

14. A method of fabricating an article of cookware, the method comprising:
a) providing a first substantially planar sheet of copper or an alloy thereof,
b) providing a second substantially planar sheet of stainless steel,
c) drawing the first planar sheet to form a first perform that is a fluid containing vessel,
d) drawing the second planar sheet to form a second perform that is a fluid containing vessel that nests within the first perform, each fluid containing vessel having a bottom surface and surrounding sidewalls extending upward therefrom,
e) nesting the second perform within the first perform to form a subassembly,
f) bonding the interface between the first and second perform to form a first bonded prefrom,
g) ironing the first bonded preform such that the thickness in the copper layer in the surrounding sidewalls is reduced in thickness to below that of the copper layer in the bottom surface.

15. The method of claim 14 wherein said step of bonding comprises brazing the first preform to the second preform.

16. The method of claim 15 wherein said step of brazing is performed before said step of ironing.

17. The method of claim 15 wherein said step of bonding further comprises bonding an aluminum layer between the first and second preform.

18. The method of claim 17 wherein said step of bonding the aluminum layer comprises impact bonding.

19. The method of claim 15 further comprising a step of laser welding the first and second preforms together along an annulus that circumscribes the surrounding sidewalls at the portion thereof intended to form the rim of the article of cookware.

20. The method of claim 19 further comprising a step of trimming the bonded preforms at the position of the laser weld to form the rim in the article of cookware.
